(19) United States
(12) Patent Application Publication
(10) Pub. No.: US 2020/0378185 A1
(43) Pub. Date: Dec. 3, 2020

(54) STEP LADDER WITH ARMREST

(71) Applicant: New-Tec Integration (Xiamen) Co., Ltd., Xiamen City (CN)

(72) Inventor: Luhao LENG, Xiamen City (CN)

(21) Appl. No.: 16/996,251

(22) Filed: Aug. 18, 2020

Related U.S. Application Data
(63) Continuation of application No. PCT/CN2019/076078, filed on Feb. 25, 2019.

(30) Foreign Application Priority Data
Feb. 26, 2018 (CN) 201820271131.7

(51) Int. Cl. E06C 7/18; E06C 1/20; E06C 7/06

(52) U.S. Cl. CPC E06C 7/182; E06C 7/06; E06C 1/20

(57) ABSTRACT

The step ladder with the armrest comprises two front legs, two rear legs, at least one rung, and an armrest. The armrest comprises a lateral tube, two vertical tubes, and a lock mechanism. The lateral tube is connected to top ends of the two vertical tubes, and the two vertical tubes are respectively and movably disposed in the two front legs. The lock mechanism comprises a link rod disposed in the lateral tube, two push rods, two pins, two pin springs, and two push rod springs respectively disposed in the two vertical tubes. The two push rod springs drive the two push rods to move upward to abut the link rod. The two pin springs drive the two pins to move laterally out of the through holes the two vertical tubes to be disposed in two of the plurality of positioning holes.

### RELATED APPLICATIONS

This application is a continuation of and claims priority to International Patent Application PCT/CN2019/076078, filed on Feb. 25, 2019, which claims priority to Chinese Patent Application 201820271131.7, filed on Feb. 26, 2018. International Patent Application PCT/CN2019/076078 and Chinese Patent Application 201820271131.7 are incorporated herein by reference.

### FIELD OF THE DISCLOSURE

The present disclosure relates to a step ladder.

### BACKGROUND OF THE DISCLOSURE

Ladders are a tool that we often need to use in our lives for climbing, such as for replacing light bulbs, roof maintenance, interior decoration, and so on. There are many different types/structures of ladders, such as straight ladders, single-sided step ladders, and double-sided step ladders. When a step ladder is in use, the step ladder can be unfolded and stably disposed on the ground. When the step ladder is not in use, the step ladder can be folded and stored conveniently. Therefore, step ladders are very convenient to use and are the first choice of consumers.

Step ladders are classified according to their functions and can be further divided into step ladders with an armrest and step ladders without an armrest. The armrest can provide support when the user climbs high on the step ladder and can provide better security for the user.

At present, in step ladders with armrests, the armrest is retractably connected to ladder legs through a pair of link rods, and a switching mechanism is disposed between each link rod of the pair of link rods and a corresponding one of the ladder legs. The user needs to press the two switch mechanisms down at the same time using both hands to enable the armrest to move upward or downward. Moreover, when the armrest moves upward or downward, it is necessary to ensure the armrest stays horizontal, otherwise it is easy for one side to get stuck. Therefore, it is very inconvenient for one person to operate.

### BRIEF SUMMARY OF THE DISCLOSURE

The present disclosure provides a step ladder with armrest to enable the armrest to move upward or downward.

In order to solve the aforementioned technical problems, a technical solution of the present disclosure is as follows.

A step ladder with an armrest comprises two front legs, two rear legs, and at least one rung. The two front legs are symmetrically disposed on two sides of the at least rung, and the two rear legs are symmetrically disposed on the two sides of the at least one rung. Each of the two front legs and a corresponding one of the two rear legs disposed on a same side of the at least one rung are pivotally connected to define a foldable structure intersecting at a preset angle. The step ladder with the armrest further comprises an armrest. The armrest comprises a lateral tube, two vertical tubes, and a lock mechanism. The lateral tube is connected to top ends of the two vertical tubes, and the two vertical tubes are respectively and movably disposed in the two front legs. The lateral tube is in communication with the two vertical tubes. The lock mechanism comprises a link rod disposed in the lateral tube, two push rods respectively disposed in the two vertical tubes, two pins respectively disposed in the two vertical tubes, two pin springs respectively disposed in the two vertical tubes, and two push rod springs respectively disposed in the two vertical tubes. The two push rod springs drive the two push rods to move upward to abut the link rod. The lateral tube comprises an opening, and the link rod is disposed with a button. The button extends out of the lateral tube through the opening. Each of the two vertical tubes comprises a through hole corresponding to a corresponding one of the two pins, and each of the two front legs respectively comprises a plurality of positioning holes corresponding to a corresponding one of the two pins. The two pin springs each drives a corresponding one of the two pins to be disposed in one of the plurality of positioning holes. When the armrest moves upward or downward, the button is pressed down, the link rod counteracts elastic forces of the two push rod springs to drive the two push rods to move downward or upward, and the two push rods counteract elastic forces of the two pin springs to drive the two pins to retract into the two vertical tubes.

Compared with existing techniques, the technical solution provided by the present disclosure has the following advantages.

Since the lateral tube and the two vertical tubes of the armrest are connected to each other, the two ends of the link rod can be connected to the two push rods concurrently. Therefore, the link rod is pressed downward to control the two push rods to move simultaneously, so that the two pins retract into the two vertical tubes simultaneously. In the step ladder of the present disclosure, the button protrudes out of the lateral tube so as to achieve control through a single point, and the operation is very convenient. The two push rods and the link rod define a frame structure to facilitate the two push rods being pushed in parallel, and the structure is stable and reliable.

### BRIEF DESCRIPTION OF THE DRAWING

The present disclosure will be further described below with the combination of the accompanying drawings and the embodiments.

FIG. 1 illustrates a perspective view of a step ladder with an armrest of an embodiment when the step ladder with the armrest is unfolded and the arm rest moves upward.

FIG. 2 illustrates a perspective view of FIG. 1 when the step ladder with the armrest is folded and the arm rest moves upward.

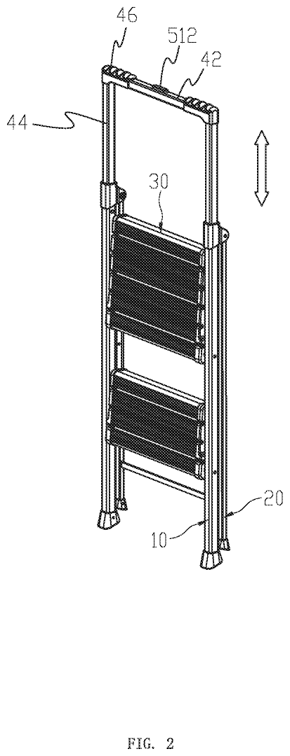

FIG. 3 illustrates a lock mechanism of FIG. 1 when the arm rest of the step ladder with the armrest moves upward.

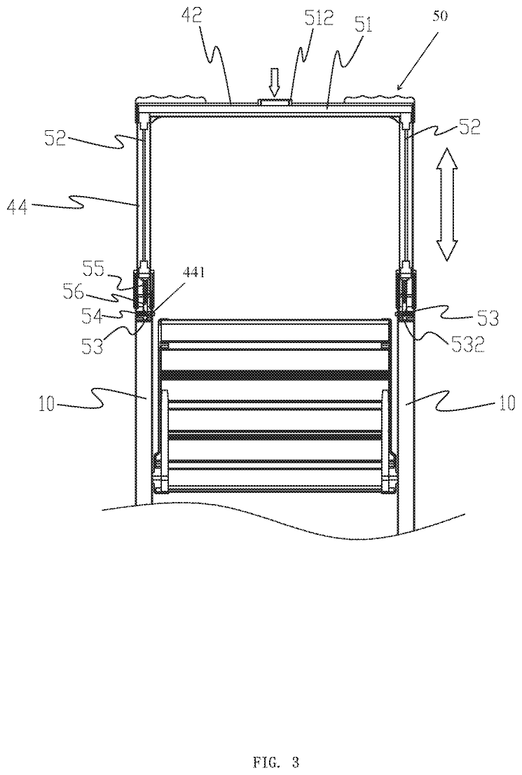

FIG. 4 illustrates a perspective view of the step ladder with the armrest of the embodiment when the step ladder with the armrest is unfolded and the arm rest moves downward.

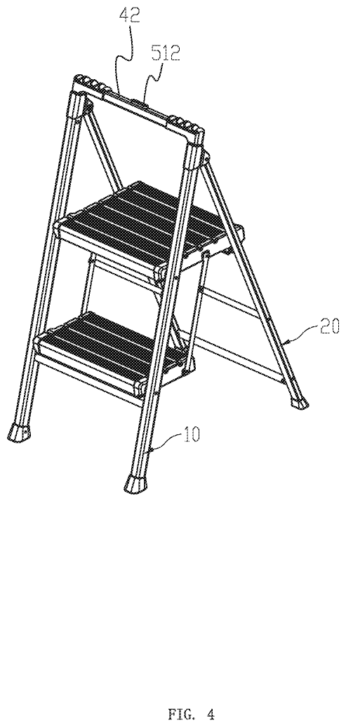

FIG. 5 illustrates a perspective view of FIG. 1 when the step ladder with the armrest is folded and the arm rest moves downward.

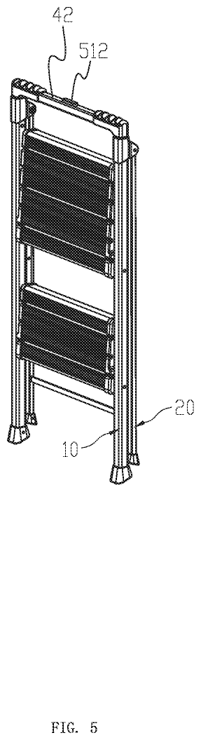

FIG. 6 illustrates the lock mechanism of FIG. 1 when the arm rest of the step ladder with the armrest moves downward.

FIG. 7 illustrates a perspective view of a step ladder with an armrest of another embodiment of the present disclosure.

### DETAILED DESCRIPTION OF THE EMBODIMENTS

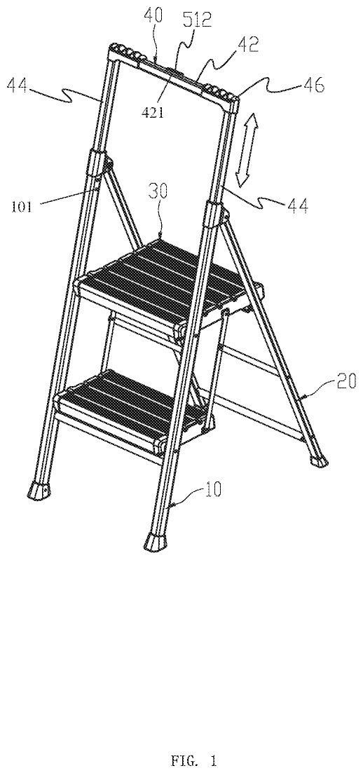

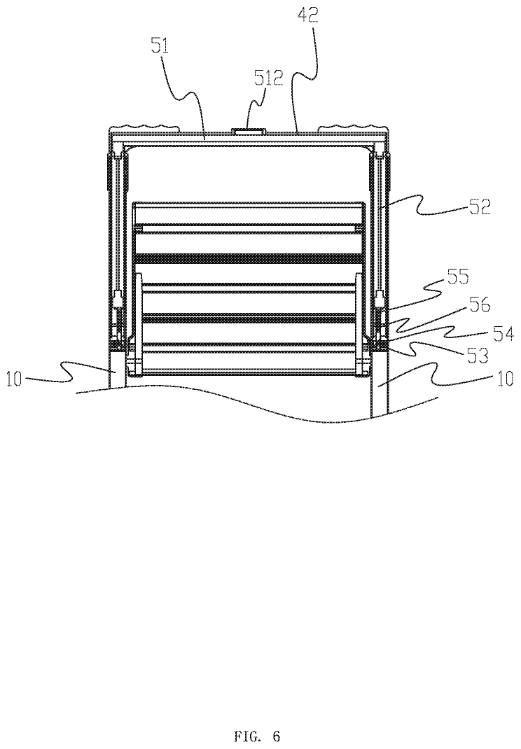

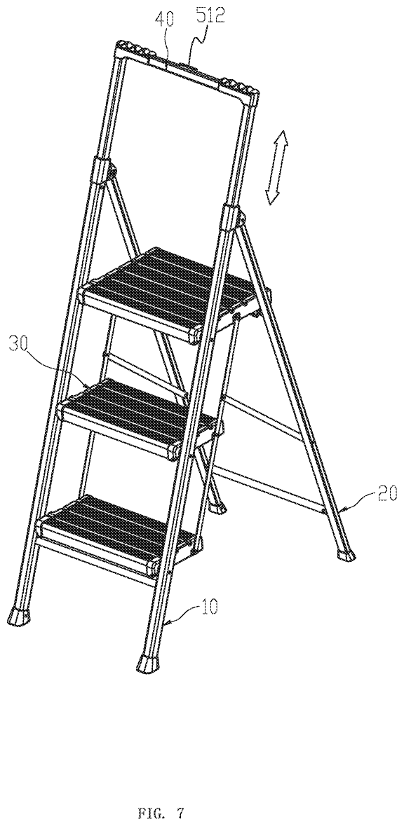

Referring to FIGS. 1 and 6, a step ladder with an armrest comprises two front legs 10, two rear legs 20, and two rungs 30 (with reference to FIG. 7, the number of rungs 30 can be one or multiple). The two front legs 10 are symmetrically disposed on two sides of the two rungs 30, and the two rear legs 20 are symmetrically disposed on the two sides of the two rungs 30. A first front leg 10 of the two front legs 10 and a first rear leg 20 of the two rear legs 20 disposed on a same side of the two rungs 30 are pivotally connected to define a foldable structure intersecting at a preset angle (e.g., to define a herringbone-shaped foldable structure). The step ladder with the armrest further comprises an armrest 40. The armrest 40 comprises a lateral tube 42 and two vertical tubes 44. The lateral tube 42 is connected to top ends of the two vertical tubes 44, and the two vertical tubes 44 are respectively and movably disposed in the two front legs 10. The lateral tube 42 is in communication with the two vertical tubes 44. The armrest 40 further comprises a lock mechanism 50. The lock mechanism 50 comprises a link rod 51 disposed in the lateral tube 42, two push rods 52 respectively disposed in the two vertical tubes 44, two pins 53 respectively disposed in the two vertical tubes 44, two pin springs 54 respectively disposed in the two vertical tubes 44, and two push rod springs 55 respectively disposed in the two vertical tubes 44.

In a normal state, the two push rod springs 55 drive the two push rods 52 to move upward to abut the link rod 51. The lateral tube 42 comprises an opening 421, and the link rod 51 is disposed with a button 512. The button 512 extends out of the lateral tube 42 through the opening 421. Each of the two vertical tubes 44 comprises a through hole 441 corresponding to a corresponding one of the two pins 53, and each of the two front legs 10 respectively comprises a plurality of positioning holes 101 corresponding to a corresponding one of the two pins 53. The two pin springs 54 each drive a corresponding one of the two pins 53 to extend out of the through holes 441 of a corresponding one of the two vertical tubes 44 to be disposed in one of the plurality of positioning holes 101.

When the armrest 40 moves upward or downward, the button 512 is pressed down, the link rod 51 counteracts elastic forces of the two push rod springs 55 to drive the two push rods 52 to move downward, the two push rods 52 counteract elastic forces of the two pin springs 54 to drive the two pins 53 to retract into the two vertical tubes 44. Therefore, the two vertical tubes 44 are configured to slide in the two front legs 10.

A bottom portion of each of the two push rods 52 is connected to an inserting rod 56. The two pins 53 each comprises an inserting hole 532. Each of a side wall of the inserting holes 532 and a bottom surface of a corresponding one of the inserting rods 56 are inclined surfaces that cooperate with each other. The two pushing rods 52 move downward to drive the two pins 53 to move laterally due to the cooperation of the inclined surfaces, and therefore the structure is simple.

The two pushing rod spring 55 each surrounds a corresponding one of the two inserting rods 56. A top portion of the lateral tube 42 comprises the opening 421, and the button 512 extends out of the lateral tube 42 in an upward direction. In some embodiments, the opening 421 can also be disposed on a bottom portion of the lateral tube 42.

Two ends of the lateral tube 42 are disposed with armrest covers 46.

It will be apparent to those skilled in the art that various modifications and variation can be made in the present disclosure without departing from the spirit or scope of the invention. Thus, it is intended that the present disclosure cover the modifications and variations of this invention provided they come within the scope of the appended claims and their equivalents.

### INDUSTRIAL APPLICABILITY

The step ladder with the armrest of the present disclosure comprises two front legs, two rear legs, and at least one rung. The step ladder with the armrest further comprises an armrest. The armrest comprises a lateral tube, two vertical tubes, and a lock mechanism. The lateral tube is connected to top ends of the two vertical tubes, and the two vertical tubes are respectively and movably disposed in the two front legs. The lock mechanism comprises a link rod disposed in the lateral tube, two push rods, two pins, two pin springs, and two push rod springs respectively disposed in the two vertical tubes. The two push rod springs drive the two push rods to move upward to abut the link rod. The lateral tube comprises an opening, and the link rod is disposed with a button. The button extends out of the lateral tube through the opening. Each of the two vertical tubes comprises a through hole corresponding to a corresponding one of the two pins, and each of the two front legs respectively comprises a plurality of positioning holes corresponding to a corresponding one of the two pins. The two pin springs each drives a corresponding one of the two pins to move laterally out of the through hole of a corresponding one of the two vertical tubes to be disposed in one of the plurality of positioning holes. The link rod is pressed downward to control the two push rods to move simultaneously, so that the two pins retract into the two vertical tubes simultaneously and so as to achieve control through a single point. The operation is therefore very convenient.

What is claimed is:

1. A step ladder with an armrest, comprising:
two front legs,
two rear legs,
at least one rung, and
an armrest, wherein:
the two front legs are symmetrically disposed on two sides of the at least one rung,
the two rear legs are symmetrically disposed on the two sides of the at least one rung,
each of the two front legs and a corresponding one of the two rear legs disposed on a same side of the at least one rung are pivotally connected to define a foldable structure intersecting at a preset angle,
the armrest comprises a lateral tube, two vertical tubes, and a lock mechanism,
the lateral tube is connected to top ends of the two vertical tubes,
the two vertical tubes are respectively and movably disposed in the two front legs,
the lateral tube is in communication with the two vertical tubes,
the lock mechanism comprises a link rod disposed in the lateral tube, two push rods respectively disposed in the two vertical tubes, two pins respectively disposed in the two vertical tubes, two pin springs respectively disposed in the two vertical tubes, and two push rod springs respectively disposed in the two vertical tubes,
the two push rod springs drive the two push rods to move upward to abut the link rod,
the lateral tube comprises an opening,
the link rod is disposed with a button,
the button extends out of the lateral tube through the opening,
each of the two vertical tubes comprises a through hole corresponding to a corresponding one of the two pins,
each of the two front legs respectively comprises a plurality of positioning holes corresponding to a corresponding one of the two pins,
the two pin springs each drive a corresponding one of the two pins to be disposed in one of the plurality of positioning holes, and
when the armrest moves upward or downward:
the button is pressed down,
the link rod counteracts elastic forces of the two push rod springs to drive the two push rods to move downward or upward, and
the two push rods counteract elastic forces of the two pin springs to drive the two pins to retract into the two vertical tubes.

2. The step ladder with the armrest according to claim 1, wherein:
a bottom portion of each of the two push rods is connected to an inserting rod,
the two pins each comprises an inserting hole, and
a side wall of each of the inserting holes and a bottom surface of a corresponding one of the two push rods are inclined surfaces that cooperate with each other.

3. The step ladder with the armrest according to claim 1, wherein the two pin springs each drives the corresponding one of the two pins to move laterally out of the through hole of a corresponding one of the two vertical tubes to be disposed in one of the plurality of positioning holes.

4. The step ladder with the armrest according to claim 2, wherein the two push rod springs each surrounds a corresponding one of the two push rods.

5. The step ladder with the armrest according to claim 1, wherein the opening is disposed on a top portion of the lateral tube.

6. The step ladder with the armrest according to claim 1, wherein the opening is disposed on a bottom portion of the lateral tube.

7. The step ladder with the armrest according to claim 1, wherein two ends of the lateral tube are respectively disposed with an armrest cover.
